(19) United States
(12) Patent Application Publication
(10) Pub. No.: US 2011/0259998 A1
(43) Pub. Date: Oct. 27, 2011

(54) CONFIGURATION OF A REAR FUSELAGE TAIL CONE OF AN AIRCRAFT WITH AN AUXILIARY POWER UNIT

(76) Inventor: Pablo Timoteo SANZ MARTÍNEZ, Paracuellos Del Jarama (Madrid) (ES)

(21) Appl. No.: 13/091,185

(22) Filed: Apr. 21, 2011

(30) Foreign Application Priority Data
Apr. 26, 2010 (ES) P201030600

(51) Int. Cl. B64D 27/00; B64C 1/10; B23P 11/00; B64D 41/00

(52) U.S. Cl. 244/54; 29/525.01

(57) ABSTRACT

Configuration of a rear fuselage tail cone of an aircraft with an auxiliary power unit, whereby a fire compartment of the rear fuselage tail cone defines a housing for the auxiliary power unit in which the auxiliary power unit is housed laterally and asymmetrically with respect to a longitudinal axis (X) of the rear fuselage tail cone and the auxiliary power unit is directly fasten attached to a structural skin wall of the housing. Additionally, by struts or rods attached to opposite side and upper structural skin wall of the fire compartment.

### OBJECT OF THE INVENTION

The object of the present invention is to obtain an optimum relationship between the parasitic drag generated by a flying aircraft and the constantly increasing size of its auxiliary power unit (from now on “APU”) due to the constantly increasing power requirements that an aircraft has. This means, that the invention aims to solve the problem of installing a cumbersome APU in a small space, being the small space the rear fuselage tail cone. Furthermore, the aim of the invention can be expressed as to reduce the size of the rear fuselage tail cone being, at the same time, able to house a constantly increasing in size APU.

For achieving above-mentioned purposes the invention describes a new disposal arrangement for the APU inside the fire compartment of the rear fuselage tail cone.

Another object of the present invention relates to a new supporting arrangement associated with the new disposal arrangement described hereto.

A further object of the present invention is to relax ground elevators requirements used in maintenance operations, as well as to improve operations such as allocation and replacing of the APU in the rear fuselage tail cone without adding any additional restriction in the elevators when performing any task in the tail cone especially due to tail cone maintenance door aperture.

### FIELD OF THE INVENTION

The present invention falls within the aeronautical industry and relates to the configuration of a rear fuselage tail cone of an aircraft.

More particularly, the present invention relates to the disposal of an APU housed in the fire compartment of a rear fuselage tail cone of an aircraft and its associated supporting arrangements.

### BACKGROUND OF THE INVENTION

It is well known in the aeronautical industry that the rear fuselage tail cone of an aircraft, generally known as tail cone, houses at least one APU which serves for the following main functions:
to provide power to aircraft systems when the main engines are not running;
to enable starting the main engines without need for external power;
to provide power to the aircraft when the primary engines are not running, for example, while the aircraft is waiting at an airport gate;
to generate electrical power for aircraft systems; and
to provide hot air for the pneumatic systems. This hot air feeds the air conditioning system and/or the anti ice system.

The demand required to the APU depends on the aircraft system architecture. For example, the pneumatic system might not be requested for full electric system architecture.

Housing the APU in the rear fuselage tail cone is quite helpful in case of a fire generated in the APU as the rear fuselage tail cone is isolated from the pressure chamber of the aircraft.

Over the course of time, aircraft manufacturers have come under increasing pressure to enlarge the amount of power supplied by the APU to the aircraft, hence the size of the APU becomes larger and heavier and the tail cone maintenance shroud required for carrying out maintenance works in the APU turn out to be bigger and bigger, thus entailing a bigger tail cone shape which is in contradiction with the flying principle of aerodynamic efficiency that needs to reduce the parasitic drag generated by a flying aircraft. This means that the shape of the tail cone should tend to minimize its size and should not tend to enlarge as it is occurring nowadays.

Normally, the APU is housed in the tail cone, inside the fire compartment. The fire compartment is separated from the rest of the tail cone structure by fire walls.

In classic tail cones, the APU is placed inside the fire compartment in a symmetrical disposition with respect to the longitudinal axis of the aircraft, supported by several rods, being accessible for maintenance from both sides of the engine.

Thus, it is inside the fire compartment of the tail cone where the accessibility to perform the different maintenance tasks around the APU equipment units and different mounts is required.

It is noted that all along the present description, when it mentions that the APU “has access” or “is accessible” it is understood that a person can be inside the same space in which the APU is housed in order to carry out maintenance works, this means that the maintenance person can be within a maintenance shroud being defined around the APU.

With above definition, the fact that the tail cone may have a local register door on one side in order to see and touch commands of the APU does not make that side of the APU “accessible” with the intended meaning of the present description.

Furthermore, the supporting of an APU in the rear fuselage tail cone of an aircraft has to comply with a replaceability/interchangeability concept of the APU as well as its associated equipment units.

Traditionally, the APU is supported by three or four anchoring points and involves a large amount of rods, around seven or eight. A problem derived from this kind of APU supporting arrangement is the large amount of time and expense involved in completing an installation. Thus, the present invention further describes a new supporting arrangement for the APU housed with the proposed new configuration that reduces the amount of rods required, therefore reducing the amount of time needed for completing an installation.

It was, therefore, desirable to find an optimum positioning for the APU inside the rear fuselage tail cone and, at the same time, find a new supporting arrangement able to attain the desired positioning maintaining the reliability standards required by the air navigation laws.

### DESCRIPTION OF THE INVENTION

The present invention is designed to overcome the drawbacks of above-mentioned traditional APU positioning.

The present invention intends to serve for the purpose of improving the relationship between the aerodynamic requirements of the tail cone with the constantly increasing size of the APU as explained above. Thus, the present invention proposes a new configuration for the rear fuselage tail cone of an aircraft with an auxiliary power unit in which a fire compartment of the rear fuselage tail cone constitutes housing for the auxiliary power unit. The auxiliary power unit being housed laterally and asymmetrically with respect to a longitudinal axis (X) of the rear fuselage tail cone and the auxiliary power unit being directly fasten attached to a structural skin wall of the fire compartment.

This new disposition, asymmetrical with respect to the longitudinal axis of the aircraft, provides single side access to the APU located inside the fire compartment of the tail cone of the aircraft.

Thus, this new asymmetrical disposition entails the fire compartment of the rear fuselage tail cone to have only a single door opening for accessing the APU instead of a traditional two-door opening. Actually, the important issue is that with the new asymmetrical disposition the opening size is being reduced, this means that the angle of access is reduced such that a single door opening is now suitable. A single door opening eases the mounting of the APU inside the fire compartment of the rear fuselage tail cone. In the description of preferred embodiments a detail example of the, easy mounting of the APU inside the fire compartment is described.

In addition, with this new asymmetrical positioning, provision is made for the other side, the side not being accessible in the terms expressed in the present description, for local register doors comprising at least an openable or removable panel for viewing commands or small portions of the APU.

The asymmetrical disposition of the APU proposed by the present invention is not only with respect to the longitudinal axis of the aircraft, but also with respect to the horizontal plane of the aircraft.

In the description of preferred embodiments a detailed example of an asymmetrical disposal of the APU inside the fire compartment of the tail cone is described. Nevertheless, it is understood that the same application is suitable for different geometries by adapting the different numerical figures.

Again, it is important to distinguish that one thing is to provide access to a person and one other thing is that a command or a portion of the APU is reachable through a window or opening.

It is important to consider that one challenge associated with APU positioning is to develop internal structures that are both lightweight, to improve overall aircraft efficiency, and capable of withstanding large thermal gradients associated with typical aircraft cruise altitudes.

Thus, for this new configuration a new supporting arrangement is described. The new supporting arrangement comprising four rods and two one-sided pins directly supported and damped on a structural wall of the fire compartment housing the APU, preferably on the primary tail cone structure, therefore reducing the amount of rods involved.

With this new supporting arrangement seven degrees of freedom can be achieved, hence the hyper static fail safe concept required by the air navigation laws is also achieved.

In the description of a preferred embodiment an example of such a supporting arrangement is described.

A further advantage of this new configuration of the APU located inside the fire compartment of the rear fuselage tail cone is related to maintenance. With the asymmetrical positioning of the APU proposed by the present invention the maintenance shroud required for carrying out maintenance and repair works is smaller, than that required by a traditional symmetrical configuration, since men access is now required only at one side.

In the preferred embodiment the new configuration described by the present invention requires only one access door. Actually the advantage lies not in the amount of doors required, but in the fact that the access space required is smaller with the asymmetrical disposition than that required with a traditional symmetrically supported APU requiring access for maintenance from both sides.

Further, the new configuration described does not constraint elevator kinematics. On the contrary, with the new configuration it is possible to relax elevators restrictions (a.e. hinged down, when tail plane is trimmed up). In addition, the new configuration eases on any ground operations where one person has to be able to perform different tasks in parallel.

A further advantage of the present invention lies in the fact that with the new configuration proposed by the invention the space assigned to the fire compartment can be incremented by means of a slanted firewall instead of a traditional straight firewall.

With this incremental space in the fire compartment the APU can be put forward, thus reducing inertial loads.

An additional advantage of the present invention applies when the tail cone interference consist of discrete joint attachments. In such cases, access door beams are much more efficient when aligned to these points. Otherwise, additional elements in the airframe as torsion boxes would be needed in order to avoid this mismatch alignment effect.

### BRIEF DESCRIPTION OF THE DRAWINGS

The present invention will be entirely understood on the basis of the following detailed description of the embodiments of the present invention and the accompanying drawings that are presented, solely as an example and which are therefore not restrictive within the present invention, and in which:

FIG. 1 depicts a rear fuselage tail cone of an aircraft showing the parts conforming it, namely: fuselage interface section, fire compartment and exhaust tail cone end;

FIG. 2 depicts a bottom view of a traditional symmetrical positioning of an APU;

FIGS. 3 depicts a bottom view of an asymmetrical positioning of an APU as proposed by the present invention;

FIGS. 3a and 3b depict examples of asymmetrical positioning of an APU wherein an alternative lateral asymmetry and an alternative horizontal asymmetry are shown respectively;

FIG. 3c shows a potential shift forward of the APU into the tail cone, by considering a slanted firewall;

FIGS. 4a to 4d depict a schematic view showing how the mounting of the APU in the asymmetrical disposition described by the present invention can be carried out and also show a lateral view of the space required for maintenance and how the APU remains accessible from one side only, having a local register door only at the other side;

FIG. 5 depicts the load scheme of the new supporting arrangement proposed by the present invention;

### REFERENCES

1: APU/auxiliary power unit
1′: APU of the prior art
2: maintenance shroud
2′: maintenance shroud of the prior art
3: access door
4: rear fuselage tail cone
5: local register door
6: tail cone fuselage interface
7: fire compartment
8: exhaust tail cone end
9: fire walls
9′: slanted fire wall
10: structural skin wall
11: damper system
12: rail track
13: ground lift system
T₁: first rod of the first of the rods mechanism
R₁: second rod of the first of the rods mechanism
T₂: first rod of the second of the rods mechanism
T₃: second rod of the second of the rods mechanism
L₁: first one-sided pin, steady pin
L₂: second one-sided pin, sliding pin

### DESCRIPTION OF A PREFERRED EMBODIMENT

The following description is provided for the benefit of the reader only, and is not intended to limit in any way the invention as set forth by the claims

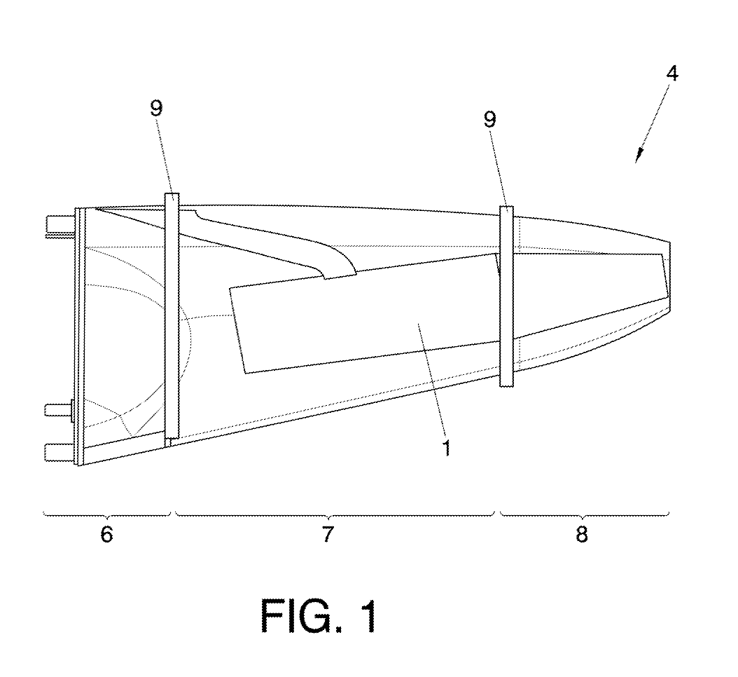

So FIG. 1 shows a rear fuselage tail cone (4) of an aircraft showing where the fire compartment (7) is located, which is between a tail cone fuselage interface (6) and an exhaust tail cone end (8), separated by fire walls (9).

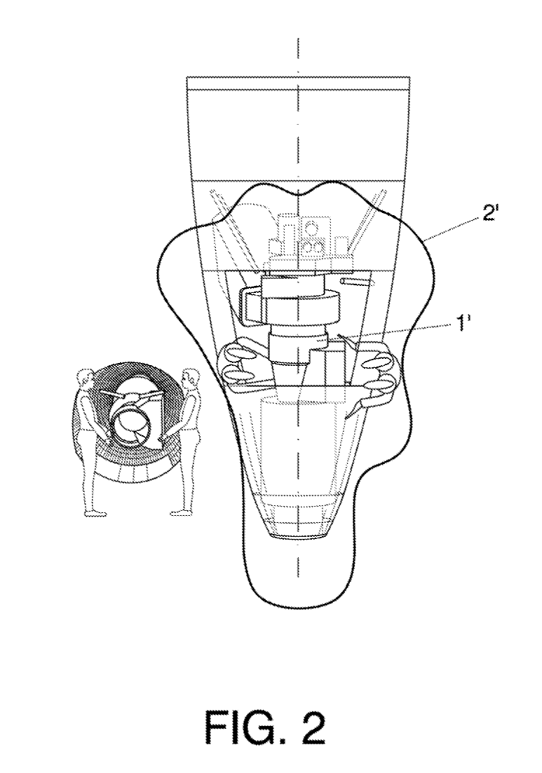

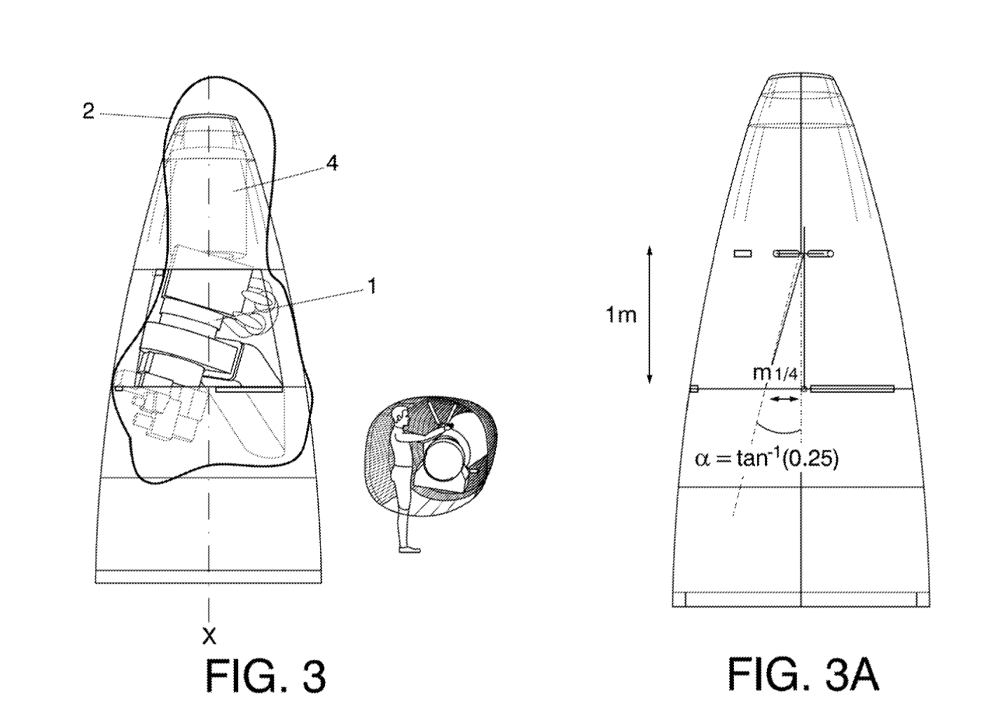

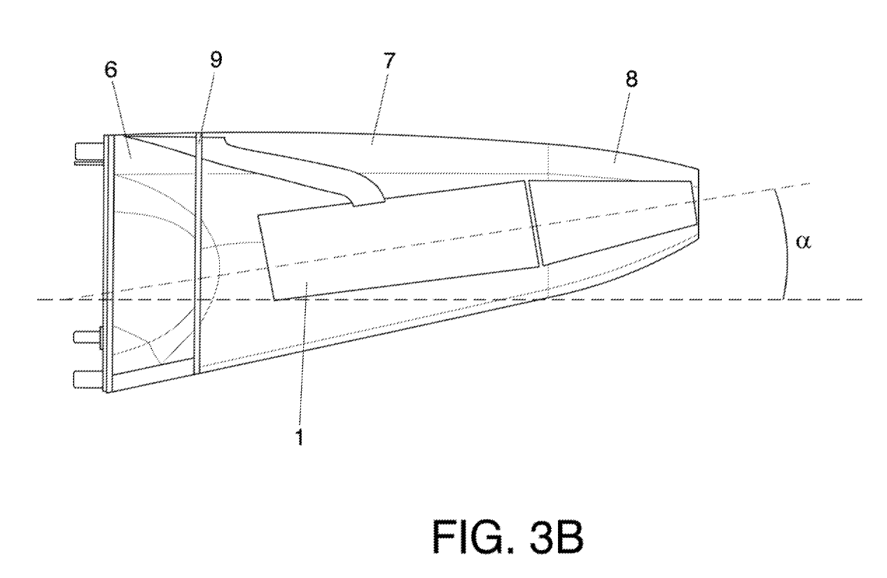

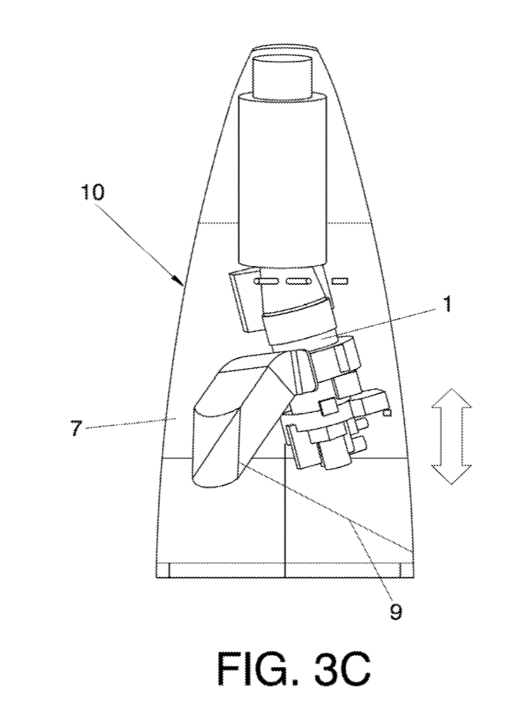

FIGS. 2 and 3 respectively show a traditional symmetrical positioning of an APU (1′) and an asymmetrical positioning of an APU (1) with respect to a longitudinal axis (X) of the aircraft proposed by the present invention, wherein it can be seen that the maintenance shroud (2) or envelope required by the present invention for carrying out maintenance works is considerably smaller than the maintenance shroud (2′) of the prior art.

FIG. 3a shows an example of an asymmetrical disposition, lateral asymmetry, in which it is shown, only for example purposes, that the inclination of the APU (1) with respect to the longitudinal axis of the plane can be ruled by the following proportion: for each meter in the longitudinal direction a quarter of meter can be inclined. And FIG. 3b completes the example of asymmetrical disposition by showing preferred embodiment of the horizontal asymmetry, preferably having an elevation angle below 12°.

FIG. 3c shows a further embodiment derived from the new configuration described by the present invention which is to shift forward the APU (1) by considering a slanted firewall (9′) instead of a traditional straight firewall (9). This shift forward of the APU (1) provides load alleviation because the center of gravity is moved closer to the landing gear in case of dynamic landing, load case that is a major constraint for the tail cone APU hoisting amplifying by an order of magnitude the weight of the engine. This embodiment further enables the APU (1) to be located in a wider area of the tail cone, thus amplifying the space around the APU (1) for installation/mounting.

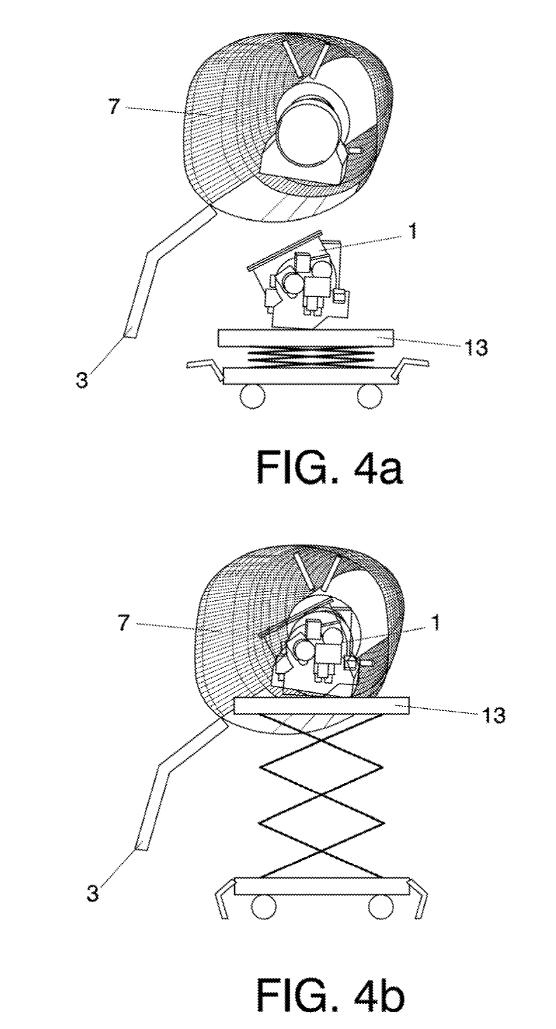

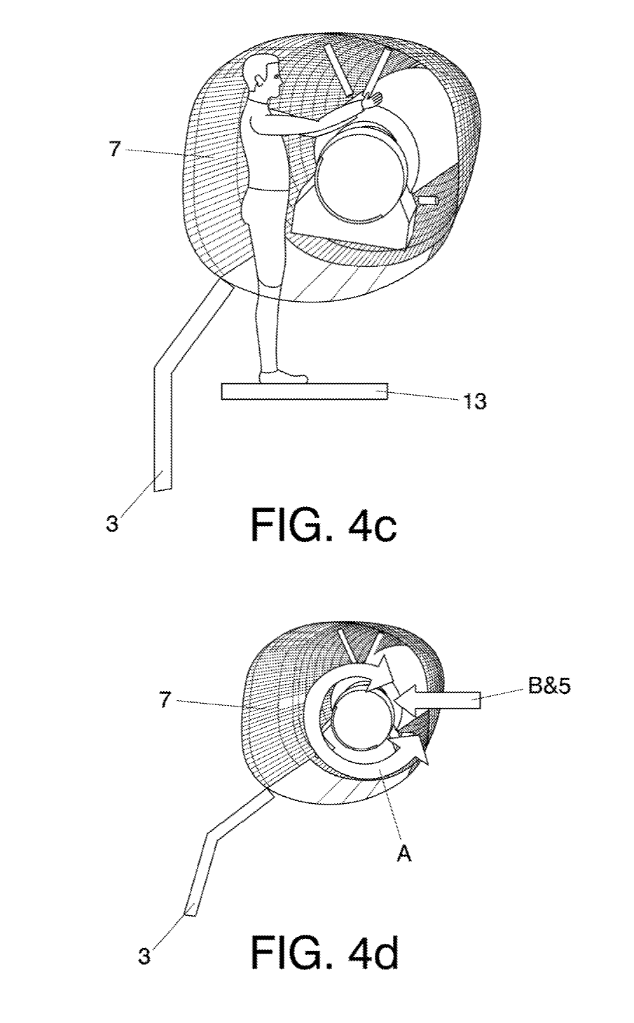

In FIGS. 4a and 4b a schematic diagram showing'how the mounting of the APU (1) in the asymmetrical disposition described by the present invention can be carried out is shown. Both figures clearly show the at least one access door (3) present in the fire compartment (7) due to the proposed disposal of the auxiliary power unit (1). The simplicity in the mounting procedure is reduced to bring a ground lift system (13) with the APU (1) on top, open the access door (3) and lift up the APU (1).

Further in FIGS. 4c and 4d a schematic view showing how a person can carry out maintenance works with the asymmetrical disposal of the APU (1) described by the present invention is shown. In particular arrow A of FIG. 4d shows the area of the APU (1) accessible in the terms of “being accessible” defined in the present description while arrow B shows the area of the APU (1) accessible/reachable through a local register door (5).

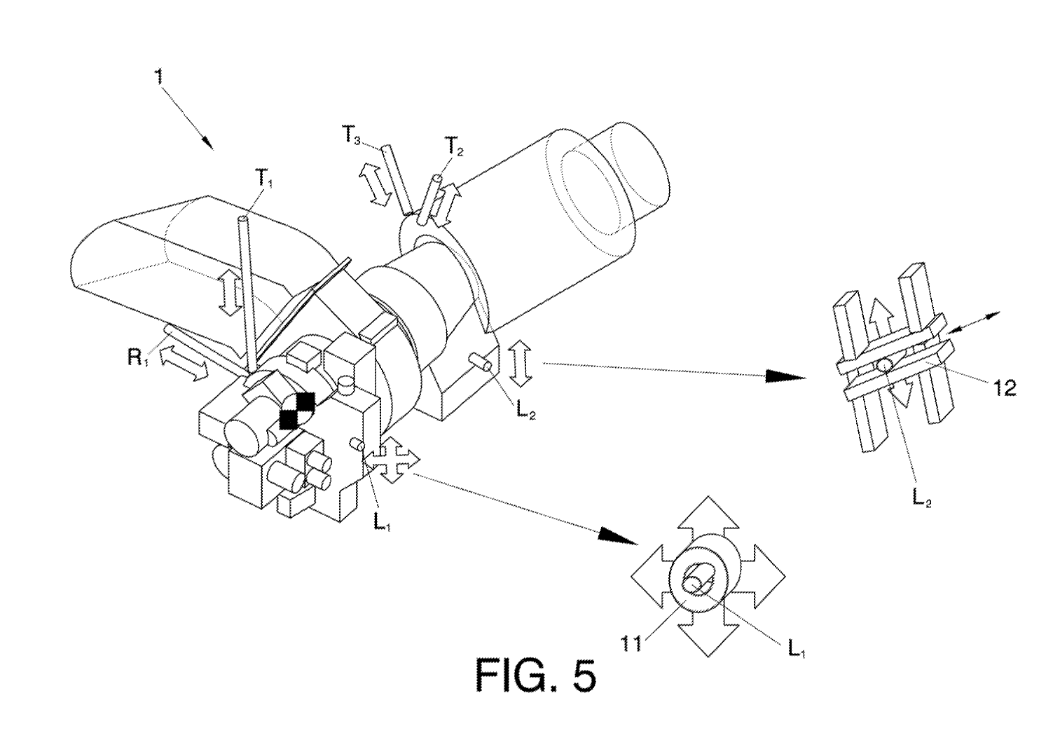

FIG. 5 shows the load scheme of the new supporting arrangement proposed by the present invention in order to achieve the asymmetrical positioning of the APU (1) described by the present invention. The arrangement comprises four rods (R₁, T₁, T₂, T₃) and two one-sided pins (L₁, L₂), such that a first of the rods mechanism (R₁ & T₁) and a second of the rods mechanism (T₂ & T₃) allow both longitudinal and radial thermal expansions. The first of the rods mechanism (R₁ & T₁) comprises a first rod (T₁), located preferably in the front top of the APU (1), and a second rod (R₁), located preferably laterally.

In a preferred embodiment the second rod (R₁) is located laterally right hand sided (RH), opposite to the APU Air Inlet location, which normally is left hand sided (LH).

The second of the rods mechanism (T₂ & T₃) comprises a first (T₂) and a second (T₃) rod, both located preferably in the aft top of the APU (1). The first one-sided pin (L₁) is preferably located in the opposite lateral of the second rod (R₁) of the first of the rods mechanism (R₁ & T₁), on the front of the APU (1) and blocks the engine, it is a steady pin. See enlarged detail of FIG. 5. The second one-sided pin (L₂) is a sliding pin preferably located in the aft of the APU (1) and holds the APU (1) vertically, allowing longitudinal expansion. See enlarged detail of FIG. 5. With these elements, seven degrees of freedom can be achieve, as shown by the arrows drawn in FIG. 5, thus achieving a hyper static fail-safe support.

Preferably, the mounting procedure derived from the new configuration described by the present invention is as follows:
a. the APU (1) is lifted by a ground lift system (13), preferably a “flying carpet” as shown in FIGS. 4a and 4b;
b. Once the APU (1) reaches the fire compartment (7) level, the structural skin wall (10) catches the first one sided pin (L₁) with a proper damper system (11) (as shown in FIG. 5 enlarged detail). The damper system preferably made of an elastomeric rubber isolated by steel;
c. After, the second one-sided pin (t₂) is installed inside a rail track (12) located in a lateral side of the structural skin wall (10). The rail track (12) adapts any longitudinal stretch the second one-sided pin (L₂) may suffer due to the high temperature range around the APU (1) when APU (1) is on/off;
d. Next, the first of the rods mechanism (R₁ & T₁) and the second of the rods mechanism (T₂ & T₃) are installed attached to the APU (1) and to the opposite side whereby the APU (1) has not been allocated in the asymmetrical positioning described by the present invention, and to an upper part of the structural skin wall (10). These rods mechanisms (R₁ & T₁ and T₂ & T₃) enable the stretching of the APU (1) and do not constraint that much the structural skin wall (10). The extremes of the rods conforming the rods mechanisms (R₁ & T₁ and T₂ & T₃) are properly damped and calibrated in length before removing the ground support of the APU (1) by the ground lift system (13);
e. Finally the APU (1) is set to be ready to fly, given the desired performance.

1. A REAR FUSELAGE TAIL CONE OF AN AIRCRAFT with an auxiliary power unit whereby a fire compartment (7) of the rear fuselage tail cone (4) constitutes housing for the auxiliary power unit (1) wherein the auxiliary power unit (1) is housed laterally and asymmetrically with respect to a longitudinal axis (X) of the rear fuselage tail cone (4) and the auxiliary power unit (1) is directly fasten attached to a structural skin wall (10) conforming the fire compartment (7).

2. THE REAR FUSELAGE TAIL CONE according to claim 1, wherein the auxiliary power unit (1) is housed asymmetrically with respect to a horizontal plane of the aircraft.

3. THE REAR FUSELAGE TAIL CONE according to claim 2, wherein the fire compartment (7) housing the auxiliary power unit (1) has at least one access door (3).

4. THE REAR FUSELAGE TAIL CONE according to claim 2, wherein the auxiliary power unit (1) housed inside the fire compartment (7) is surrounded by a maintenance shroud (2) defined by a space surrounding the auxiliary power unit (1) and suitable for carrying out maintenance works.

5. THE REAR FUSELAGE TAIL CONE according to claim 2, wherein the fire compartment (7) comprises at least one local register door (5).

6. THE REAR FUSELAGE TAIL CONE according to claim 2, wherein the fire compartment (7) further comprises a supporting arrangement for directly fastening the auxiliary power unit (1) to the structural skin wall (10) of the fire compartment whereby the supporting arrangement comprises:
four rods (R₁, T₁, T₂, T₃) defining two rods mechanisms (R₁ & T₁ and T₂ & T₃); and
two one-sided pins (L₁, L₂).

7. THE REAR FUSELAGE TAIL CONE according to claim 6, wherein the four rods (R₁, T₁, T₂, T₃) and the two one-sided pins (L₁, L₂) are arranged in such a manner that:
the first of the rods mechanism (R1 & T1) comprises a first rod (T1), located in a front top of the auxiliary power unit (1), and a second rod (R1), located laterally;
the second of the rods mechanism (T2 & T3) comprises a first rod (T2) and a second rod (T3), located both in an aft top of the auxiliary power unit (1);
the first one-sided pin (L₁) is located in an opposite lateral of the second rod (R₁) of the first of the rods mechanism (R₁ & T₁), on a front of the auxiliary power unit (1) and is steady; and
the second one-sided pin (L₂), being a sliding pin, is located in the aft of the auxiliary power unit (1), holding the auxiliary power unit (1) vertically in order to allow longitudinal expansion.

8. Method of mounting the auxiliary power unit (1) in the rear fuselage tail cone (4) as defined in claim 6 comprising the following steps:
a. To lift the auxiliary power unit (1) by a ground lift system (13);
b. Once the auxiliary power unit (1) reaches the fire compartment (7) level, next step is to catch the first one sided pin (L₁) by the structural skin wall (10) with a proper damper system (11)
c. Then to install the second one-sided pin (L₂) inside a rail track (12) located in a lateral side of the structural skin wall (10);
d. Next, to install the first of the rods mechanism (R₁ & T₁) and the second of the rods mechanism (T₂ & T₃) attached to the auxiliary power unit (1) and to the opposite side to that the auxiliary power unit (1) has been housed, and to an upper part of the structural skin wall (10);
e. Last, to set the auxiliary power unit (1) in order to be ready to fly, given the desired performance.

9. The method according to claim 8 wherein the ground lift system (13) is a “flying carpet”.

10. The method according to claim 8 wherein the damper system (11) is made of an elastomeric rubber isolated by steel.

11. The method according to claim 8 wherein the rods mechanisms (R₁ & T₁ and T₂ & T₃) comprise extremes of rods that are damped and calibrated in length before removing the ground lift system (13) supporting the auxiliary power unit (1).
